(19) United States
(12) Patent Application Publication
(10) Pub. No.: US 2023/0153440 A1
(43) Pub. Date: May 18, 2023

(54) METHOD, DEVICE, AND PLATFORM FOR VERIFYING INTEGRITY

(71) Applicant: SAMSUNG ELECTRONICS CO., LTD., Suwon-si (KR)

(72) Inventors: YUNHO YOUM, OSAN-SI (KR); MARTY KIM, SUWON-SI (KR); SEUNGHO LEE, SEOUL (KR); MYUNGSIK CHOI, HWASEONG-SI (KR)

(21) Appl. No.: 17/983,642

(22) Filed: Nov. 9, 2022

(30) Foreign Application Priority Data
Nov. 12, 2021 (KR) 10-2021-0156059
Apr. 6, 2022 (KR) 10-2022-0043064

(51) Int. Cl. G06F 21/57

(52) U.S. Cl. CPC G06F 21/572; G06F 2221/034

(57) ABSTRACT

A device connected to a platform includes a security system having device-real-time-clock (RTC) data and main firmware communicating with the platform. The security system generates a device hash from the device RTC data and the main firmware hash, and the main firmware provides a response including the device hash to the platform.

### CROSS-REFERENCE TO RELATED APPLICATION

This application is based on and claims priority under 35 U.S.C. § 119 to Korean Patent Application Nos. 10-2021-0156059 and 10-2022-0043064, filed on Nov. 12, 2021, and Apr. 6, 2022, in the Korean Intellectual Property Office, the disclosures of which are incorporated by reference herein in their entireties.

### BACKGROUND

The disclosure relates to an integrity verification method and, more particularly, to a method, a device, and a platform for generating a hash to verify integrity.

With the development of technologies such as the Internet of things (IoT) and cloud technology, technologies for platform security are being developed. Attackers are often modulating data by attacking a device connected to a platform. Therefore, the platform needs to verify whether the data of the device is modulated, that is, the integrity is compromised. However, a conventional integrity verification method is vulnerable to a replay attack in which an attacker uses a pre-stolen hash during integrity verification.

### SUMMARY

The disclosure relates to an increase in security of a platform, which is achieved by stably verifying integrity of a device against a replay attack.

According to an aspect of the disclosure, there is provided a device connected to a platform, including a security system including device real time clock (RTC) data and main firmware communicating with the platform. The security system generates a device hash from the device RTC data and the main firmware hash and the main firmware provides a response including the device hash to the platform.

According to an aspect of the disclosure, there is provided a platform connected to at least one device, including a platform root of trust (RoT) verifying integrity of a device hash and a hash table storing a main firmware hash of the at least one device. The platform RoT verifies the integrity of the device hash based on platform real time clock (RTC) data and the main firmware hash.

According to an aspect of the disclosure, there is provided a method of verifying integrity of a device connected to a platform, including synchronizing platform real time clock (RTC) data with device RTC data, the device generating a device hash from the device RTC data and a main firmware hash of the device, and the platform verifying integrity of the device hash based on the platform RTC data and a firmware hash stored in the platform.

### BRIEF DESCRIPTION OF THE DRAWINGS

Embodiments of the disclosure will be more clearly understood from the following detailed description taken in conjunction with the accompanying drawings in which:

FIG. 1 is a block diagram schematically illustrating an integrity verification environment according to an embodiment of the disclosure;

FIGS. 2A and 2B are flowcharts illustrating integrity verification methods according to a comparative example;

FIG. 3 is a block diagram illustrating a device for verifying integrity according to an embodiment of the disclosure;

FIG. 4 is a block diagram illustrating a security system according to an embodiment of the disclosure;

FIG. 5 is a block diagram illustrating a platform for verifying integrity according to an embodiment of the disclosure;

FIG. 6 is a flowchart illustrating an integrity verification method of FIGS. 7 and 9;

FIG. 7 is a flowchart illustrating operation of a device for verifying integrity when a platform requests integrity verification according to an embodiment of the disclosure;

FIG. 8 is a flowchart illustrating operation of determining a real time clock (RTC) of a verification result hash of FIG. 7;

FIG. 9 is a flowchart illustrating an operation of a platform for verifying integrity when the platform requests integrity verification according to an embodiment of the disclosure;

FIG. 10 is a flowchart illustrating integrity verification operation of FIG. 9;

FIG. 11 is a flowchart illustrating an integrity verification method of FIGS. 12 and 14;

FIG. 12 is a flowchart illustrating an operation of a device for verifying integrity when the device requests integrity verification according to an embodiment of the disclosure;

FIG. 13 is a flowchart illustrating an operation of determining an RTC of a verification result hash of FIG. 12;

FIG. 14 is a flowchart illustrating an operation of a platform for verifying integrity when a device requests integrity verification according to an embodiment of the disclosure;

FIG. 15 is a flowchart illustrating integrity verification operation of FIG. 14;

FIG. 16 is a flowchart illustrating an integrity verification method to which an open compute project (OCP) standard is applied according to an embodiment of the disclosure; and

FIG. 17 is a table illustrating a device hash to which the OCP standard is applied according to an embodiment of the disclosure.

### DETAILED DESCRIPTION OF THE EMBODIMENTS

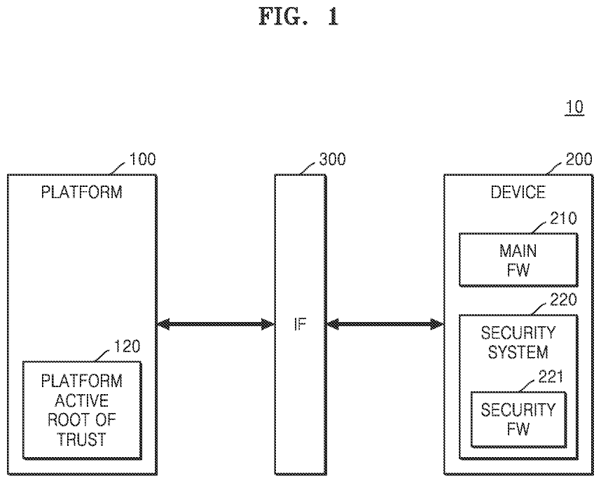

FIG. 1 is a block diagram schematically illustrating an integrity verification environment 10 according to an embodiment of the disclosure. Referring to FIG. 1, the integrity verification environment 10 may include a platform 100, a device 200, and an interface 300.

The platform 100 may include a device communicating with the device 200 through the interface 300, for example, a server or an encrypted system. In order to maintain platform security, the device 200 (for example, a solid-state drive (SSD)) connected to the platform 100 may verify whether data is modulated by attackers, that is, integrity of the device 200. In order to verify the integrity of the device 200, the platform 100 may include a platform active (PA) root of trust (RoT) 120 verifying the integrity of the device 200. In addition, the platform 100 may store firmware hashes of the device 200 in a table and may request firmware hashes of the device 200 when the device 200, which is connected to the platform 100, is booted and operates.

When firmware of the device 200 is modulated by an attacker, the firmware hashes of the device 200 may also be changed. Therefore, the platform 100 may test the integrity of the device 200 by receiving the firmware hashes of the device 200 from the device 200 and comparing the received firmware hashes with the stored firmware hashes.

When the firmware hashes of the device 200 match the stored firmware hashes, the platform 100 may determine that the device 200 has integrity and the platform 100 and the device 200 may perform a normal sequence operation. The normal sequence operation may be transmitting and receiving a signal between the platform 100 and the device 200 to drive the device 200 under the premise that the device 200 has integrity. In some embodiments, the platform 100 may transmit an integrity verification result determining that the device 200 has integrity to the device 200. The device 200 may operate normally based on the integrity verification result.

When the firmware hashes of the device 200 do not match the stored firmware hashes, the platform 100 may determine that the device 200 does not have integrity and may perform an error sequence operation. The error sequence operation may be for responding to lack of integrity of the device 200. For example, the platform 100 may perform a firmware recovery operation of initializing main firmware 210 of the device 200. In some embodiments, the platform 100 may transmit an integrity verification result determining that the device 200 does not have integrity to the device 200. The device 200 may zeroize sensitive security parameters (SSP) so that the attacker may not use the SSPs, such as a device private key, based on the integrity verification result.

The device 200 may include the main firmware 210 and a security system 220. The main firmware 210 may drive the device 200.

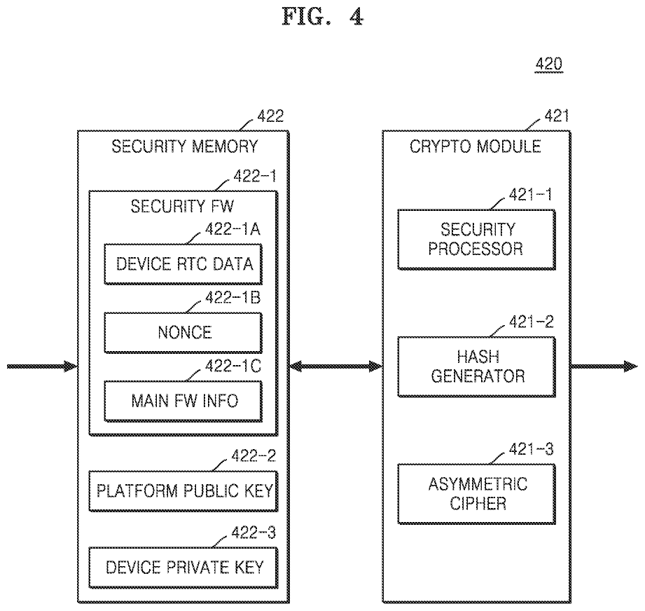

The security system 220 may correspond to the PA RoT of the platform 100 and may be referred to as an active component (AC) RoT. The security system 220 may include security firmware 221 and SSPs. The SSPs used for integrity verification may include device real time clock (RTC) data 422-1A, nonce data, and a device private key 422-3 as described later with reference to FIG. 4.

The interface 300 may change the signal transmitted and received between the platform 100 and the device 200 to fit specifications of the platform 100 and the device 200 and may transmit the changed signal.

As described later with reference to the drawings, the platform 100 may determine whether the device 200 is modulated by the integrity verification using the RTC data and may perform the error sequence operation when the device 200 is modulated to increase security of the platform 100.

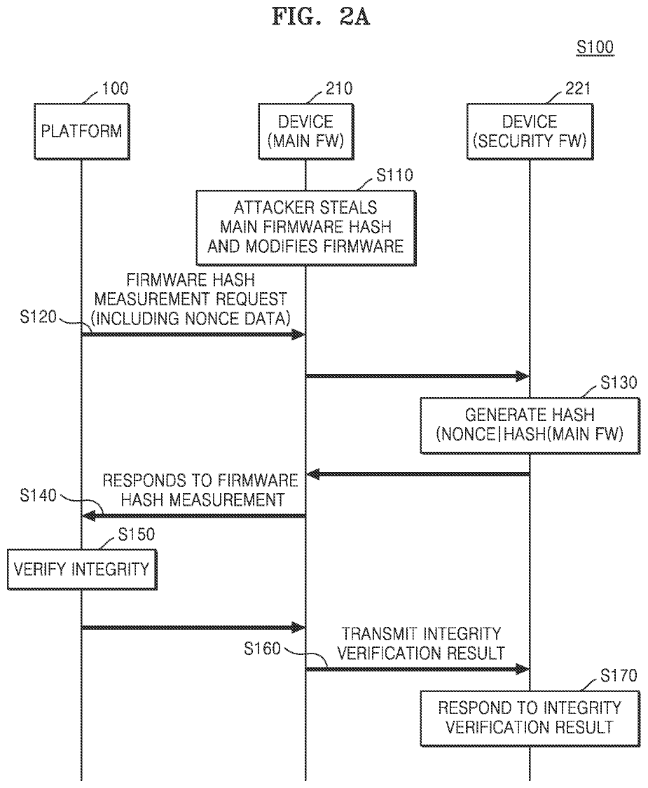

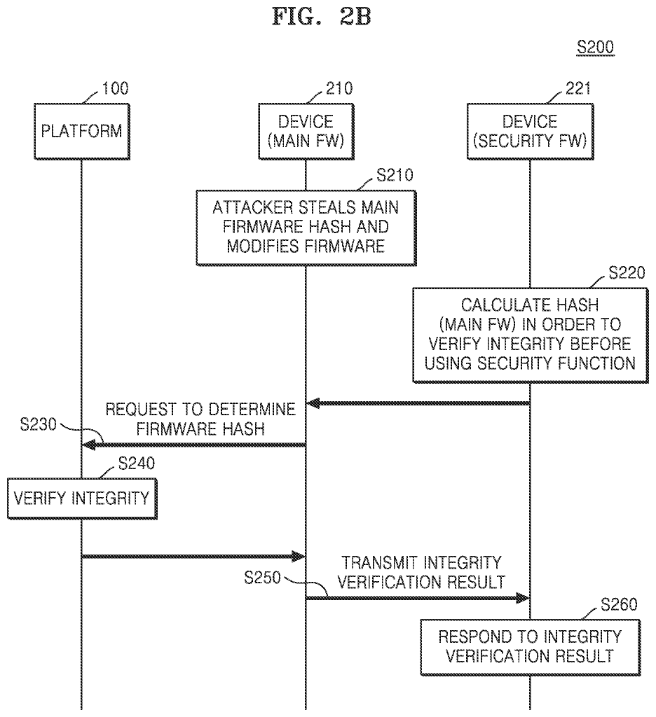

FIGS. 2A and 2B are flowcharts illustrating integrity verification methods S100 and S200 according to a comparative example.

Referring to FIGS. 2A and 2B, the integrity verification method S100 may be described by operations of the platform 100 and the main firmware 210 and the security firmware 221 of the device 200. In FIGS. 2A and 2B, the interface 300 of FIG. 1 is omitted. However, it may be understood by a person skilled in the art that the signal transmission and reception between the device 200 and the platform 100 is performed through the interface 300 as described above with reference to FIG. 1.

Referring to FIG. 2A, the integrity verification method may include a plurality of operations S110 to S170. In operation S110, an attacker may steal a main firmware hash from the main firmware 210 of the device 200 and may modulate a code of the main firmware 210 of the device 200 for hacking.

In operation S120, the platform 100 may transmit a firmware hash measurement request including the nonce data to the main firmware 210 of the device 200. The nonce data may be generated by the platform 100 and may be any number used to verify the integrity of the device 200. For example, the platform 100 may include a random number generator and the nonce data may include a random number generated by a random number generator and/or a value generated from the random number.

In operation S130, the security firmware 221 of the device 200 may generate a device hash from the main firmware hash and the nonce data. That is, the device hash may be expressed as HASH(NONCEIHASH(MAIN FW)). The attacker may perform a so-called replay attack by using stolen information without reading the main firmware hash from the main firmware 210 of the device 200 to hide the fact that the code of the main firmware 210 is modulated. In other words, the attacker may generate the device hash from the nonce data and the main firmware hash stolen in operation S110.

In operation S140, the device 200 may transmit the device hash generated in operation S130 to the platform 100 through the main firmware 210 of the device 200.

In operation S150, the platform 100 may verify integrity of the device hash received from the device 200. The integrity of the device hash may be verified by determining whether the main firmware hash of the device 200, which is stored in the platform 100, and a hash generated from the nonce data match the device hash received in operation S140. Because the device hash is generated by using the hash stolen by the attacker, the main firmware hash of the device 200, which is stored in the platform 100, and the hash generated from the nonce data may match the device hash. Therefore, the platform 100 may generate an integrity verification result having information representing that the device 200 passes the integrity verification.

In operation S160, the platform 100 may transmit the integrity verification result to the security firmware 221.

In operation S170, the security firmware 221 may perform a response based on the received integrity verification result. The security firmware 221 may perform the normal sequence operation as the response based on the integrity verification result and may not take any action against the modulation of the main firmware 210. As such, the integrity verification method of FIG. 2A is vulnerable to the replay attack of the attacker.

In addition, in the integrity verification method of FIG. 2A, integrity is not tested before using a security function (using important data that may threaten the security of the platform 100 and the device 200 when it leaks outside). Referring to FIG. 2B, in the integrity verification method, a method of testing the integrity before using the security function will be described.

Referring to FIG. 2B, the integrity verification method S200 may include a plurality of operations S210 to S260. Operations S240 to S260 may respectively correspond to operations S150 to S170 of FIG. 2A and, in FIG. 2B, description previously given with reference to FIG. 2A will not be given.

In operation S210, an attacker may steal a main firmware hash from the main firmware 210 of the device 200 and may modulate the code of the main firmware 210 of the device 200 for hacking. Information stolen by the attacker may include an integrity verification result having information representing that the device 200 passes the integrity verification.

In operation S220, the security firmware 221 of the device 200 may require the integrity verification to prevent the modulated main firmware 210 from accessing the important data before using the security function. Unlike in FIG. 2A, because the device 200 does not receive the nonce data in FIG. 2B, the security firmware 221 of the device 200 may generate a device hash without the nonce data for the integrity verification. That is, the device hashes can be expressed as HASH(MAIN FW).

In operation S230, the device 200 may transmit the device hash generated in operation S220 to the platform 100 through the main firmware 210 of the device 200.

In operation S240, the platform 100 may verify integrity of the device hash received from the device 200. The integrity of the device hash may be verified by determining whether the main firmware hash of the device 200, which is stored in the platform 100, matches the device hash received in operation S230. Because the device hash is generated by using the hash stolen by the attacker, the main firmware hash of the device 200, which is stored in the platform 100, may match the device hash. Therefore, the platform 100 may generate an integrity verification result having information representing that the device 200 passes the integrity verification.

In operation S250, the platform 100 may transmit the integrity verification result to the device 200.

In operation S260, the security firmware 221 may perform the normal sequence operation as the response based on the received integrity verification result and may not take any action against the modulation of the main firmware 210.

Therefore, it may be noted that, although the integrity is tested before using the security function, the integrity verification method is vulnerable to the replay attack.

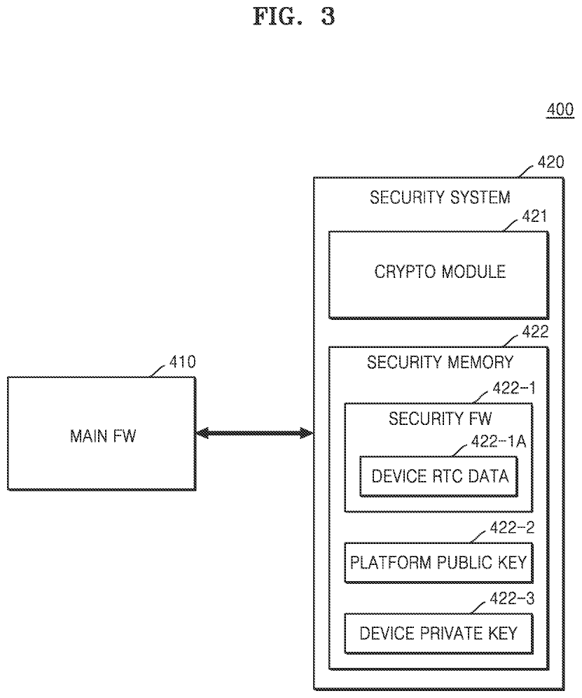

FIG. 3 is a block diagram illustrating a device 400 for verifying integrity according to an embodiment of the disclosure. The device 400 of FIG. 3 may correspond to the device 200 of FIG. 1. The device 400 may include main firmware 410 and a security system 420. The main firmware 410 may let the device 400 perform operations other than an operation related to security. The main firmware 410 may be implemented by a hardware device (for example, a separate memory device such as read only memory (ROM)) separate from the security system 420.

The security system 420 may include an encryption module 421 and security memory 422. The encryption module 421 may include hardware components physically performing cryptographic operations. The security memory 422 may include security firmware 422-1, a platform public key 422-2, and a device private key 422-3 and the security firmware 422-1 may include device RTC data 422-1A.

Access to data items (the device RTC data 422-1A, the platform public key 422-2, and the device private key 422-3) in the security system 420 corresponding to the SSP of FIG. 1 may be implemented only through the security firmware 422-1. The main firmware 410 may transmit a hash measurement request signal to the security firmware 422-1 and may receive a device hash as a result of the security system measuring a hash. In addition, because the main firmware 410 may be implemented by a hardware device (for example, a separate memory device) separate from the security system 420, the security system 420 may prevent the main firmware 410 from accessing the data items in the security system 420. Therefore, it is possible to prevent the attacker from accessing the data items in the security system 420 through the main firmware 410.

FIG. 4 is a block diagram illustrating a security system 420 according to an embodiment of the disclosure. The security system 420 may include an encryption module 421 and security memory 422. The encryption module 421, as hardware physically performing a cryptographic operation, may include a security processor 421-1, a hash generator 421-2, and an asymmetric cipher 421-3.

The security processor 421-1 may be a dedicated processor for executing functions of the security system 420.

The hash generator 421-2 may be hardware for generating a main firmware hash and a device hash. The hash generator may generate the main firmware hash from main firmware information 422-1C received from the security firmware 422-1. In addition, the hash generator 421-2 may generate the device hash by calculating the hash from the device RTC data 422-1A, the nonce data 422-1B, and the main firmware hash. For example, the hash generator 421-2 may generate the device hash by calculating the hash after serially concatenating the device RTC data 422-1A, the nonce data 422-1B, and the main firmware hash. That is, the device hash may be expressed as HASH(DEVICE RTC DATAINONCEIHASH(MAIN FW)). The order in which the hash generator 421-2 serially concatenates the data items may be set to be the same as the order in which data items are concatenated when the hash is generated by the platform 500.

The asymmetric cipher 421-3 may encrypt or decrypt data by using a public key or a private key. For example, the asymmetric cipher 421-3 may encrypt the device hash by using the platform public key 422-2.

The security memory 422 may include the security firmware 422-1, the platform public key 422-2, and the device private key 422-3. The security firmware 422-1 may include the device RTC data 422-1A, the nonce data 422-1B, and the main firmware information 422-1C.

The device RTC data 422-1A may be synchronized with platform RTC data when the device 400 is booted. The device RTC data 422-1A, changing in real time, may include data such as time, minute, or seconds. For example, the device RTC data 422-1A may change by time that has passed in units of one second from a time when the device 400 is booted. In an embodiment, the device RTC data 422-1A may be initialized to an initial value (for example, 0 hour 0 minutes 0 seconds) when the device 400 is booted and may increase by time that has passed after the device 400 is booted. In another embodiment, the device RTC data 422-1A may receive additional power, although power of the device 400 is turned off, to increase by time that has passed in units of one second. The device RTC data 422-1A may be synchronized with the platform RTC data when the device 400 is booted to have the same value as the platform RTC data. Because the main firmware 410 is prevented from accessing the device RTC data 422-1A and the platform 500 and the device 400 have the synchronized RTC data, the platform 500 may prevent the replay attack by using the device RTC data 422-1A when integrity of the device 400 is verified.

The nonce data 422-1B may be generated by the platform 500 and may be any number used to verify the integrity of the device 400. The platform 500 may transmit a firmware hash measurement request including the nonce data 422-1B to the device 400. The security firmware 422-1 may receive the nonce data 422-1B from the platform 500 to store the nonce data 422-1B.

The main firmware information 422-1C may be an address and a size of the main firmware 410. The security firmware 422-1 may read the address and size of the main firmware 410 from the main firmware 410 to store the address and size of the main firmware 410 as the main firmware information 422-1C. In an embodiment, the security system 420 may further include a direct memory access (DMA). The security firmware 422-1 may read a code of the main firmware, by the size of the main firmware (e.g., identifying the size of the main firmware), from the address of the main firmware 410 in which the main firmware 410 is stored by using the DMA. The main firmware information 422-1C may be used to generate the main firmware hash by the hash generator 421-2.

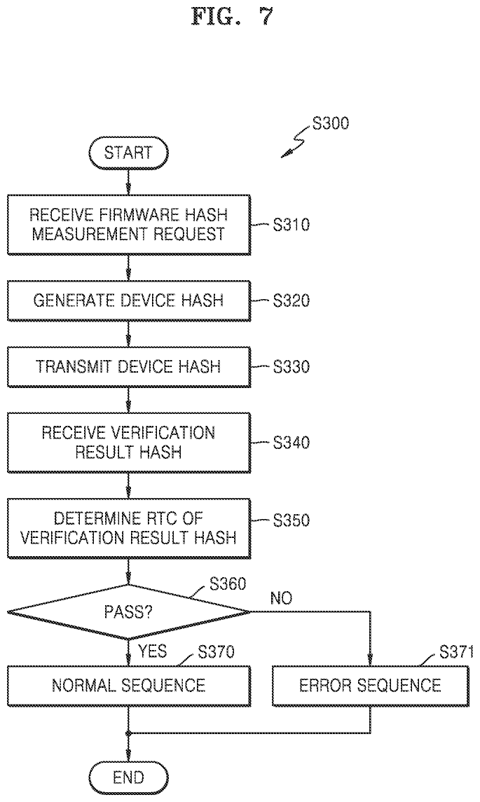

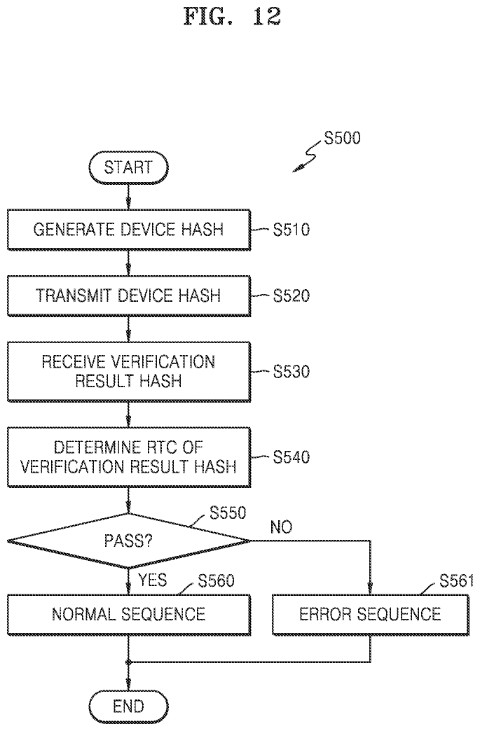

The platform public key 422-2 may be used for the device 400 to encrypt the device hash by the asymmetric cipher 421-3. As described with reference to FIGS. 7 and 12, the device 400 may encrypt the device hash by using the platform public key 422-2. In addition, the platform public key 422-2 may be used to determine an electronic signature of a verification result hash. According to the disclosure, the electronic signature may be obtained by encrypting data to be transmitted to an opponent by using a private key of a user. The opponent may decrypt the electronically signed data by using a public key of the user who encrypts the data and may determine who is the user. The platform 500 may electronically sign the verification result hash by using the platform private key 524 and the device 400 may determine whether an electronic signature of the electronically signed verification result hash is valid by using the platform public key 422-2.

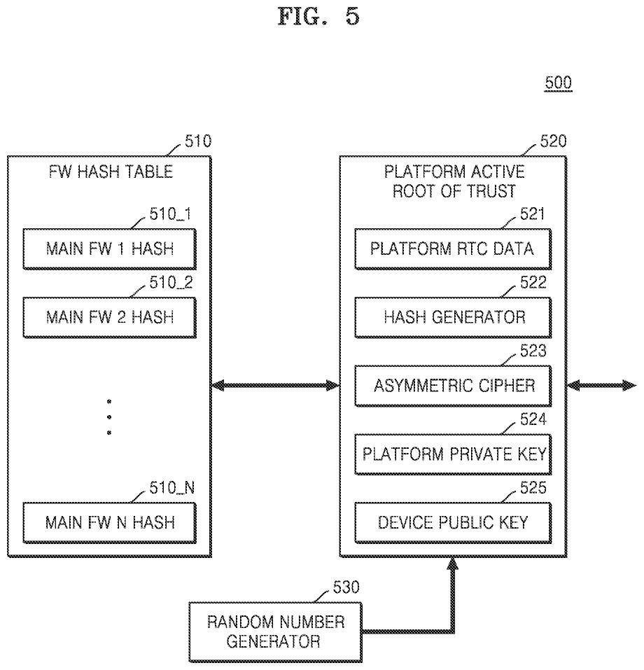

The platform private key 422-3 may be used for the device 400 to encrypt the device hash by the asymmetric cipher 421-3. As described with reference to FIGS. 7 and 12, the device 400 may electronically sign the device hash by using the device private key 422-3. In addition, the device private key 422-3 may be used to decrypt the encrypted verification result hash. The platform 500 may encrypt the verification result hash by using the device public key 525 of FIG. 5 and the device 400 may decrypt the encrypted verification result hash by using the device private key 422-3.

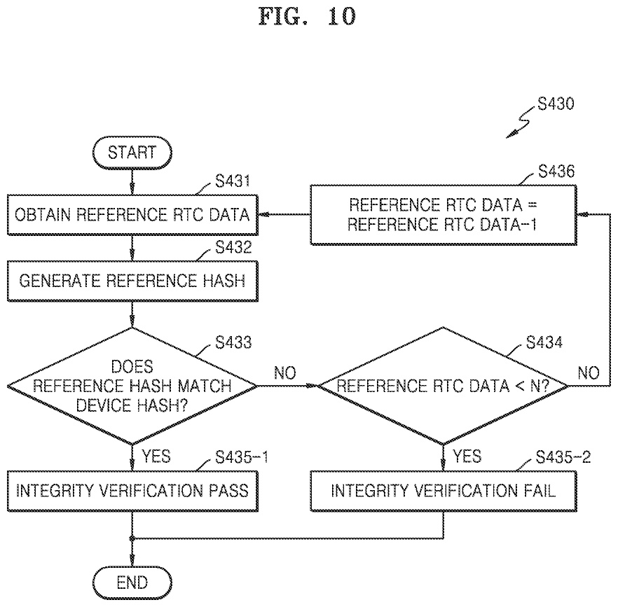

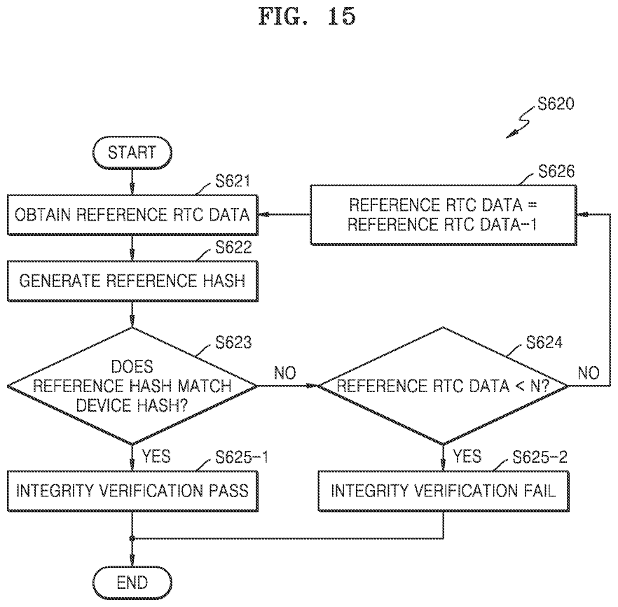

FIG. 5 is a block diagram illustrating a platform 500 for verifying integrity according to an embodiment of the disclosure. The platform 500 may include a firmware hash table 510, a PA RoT 520, and a random number generator 530. The firmware hash table 510 may store the main firmware hashes of the device 400 connected to the platform 500. That is, the firmware hash table 510 may include first to Nth main firmware hashes 510-1 to 510-N. The first to Nth main firmware hashes 510-1 to 510-N stored in the firmware hash table 510 may be used to verify the device hash as described with reference to FIGS. 10 and 15.

The PA RoT 520 may correspond to the security system 420 of the device 400. The PA RoT 520 may include platform RTC data 521, a hash generator 522, an asymmetric cipher 523, a platform private key 524, and a device public key 525.

The platform RTC data 521 may correspond to the device RTC data 422-1A of FIG. 4. The platform RTC data 521 may be synchronized with the device RTC data 422-1A when the device 400 is booted. The platform RTC data 521, changing in real time, may include data such as time, minute, or seconds. Because: (1) the main firmware 410 is prevented from accessing the device RTC data 422-1A and (2) the platform 500 and the device 400 have the synchronized RTC data, the platform 500 may prevent the replay attack by using the platform RTC data 521 when the integrity of the device 400 is verified.

The hash generator 522 may correspond to the hash generator 421-2 of FIG. 4. The hash generator 522 may generate a reference hash from the platform RTC data 521, the nonce data received from the random number generator 530, and the main firmware hash. For example, the hash generator 522 may generate the reference hash by calculating the hash after serially concatenating the platform RTC data 521, the nonce data, and the main firmware hash. That is, the reference hash may be expressed as HASH(PLATFORM RTC DATAINONCEIHASH(MAIN FW)). The order in which the hash generator 522 serially concatenates the data items may be set to be the same as the order in which the data items are concatenated when the hash is generated by the device 400.

The asymmetric cipher 523 may encrypt or decrypt data by using a public key or a private key. For example, the asymmetric cipher 523 may encrypt the verification result hash by using the device public key 525.

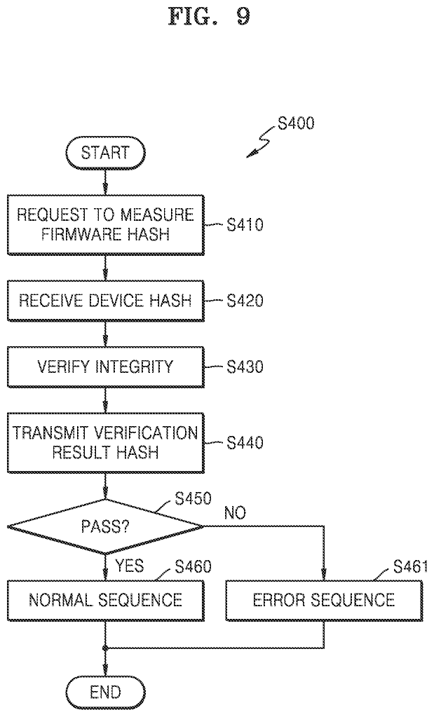

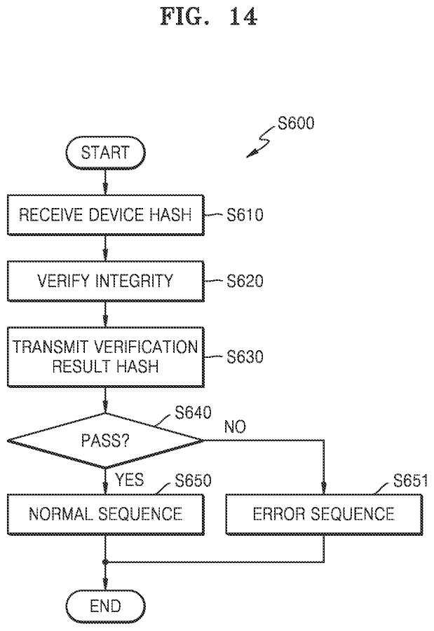

The platform private key 524 may be used for the platform 500 to encrypt the verification result hash by the asymmetric cipher 523. As described with reference to FIGS. 9 and 14, the platform 500 may electronically sign the verification result hash by using the platform private key 524 and the device 400 may determine whether an electronic signature of the electronically signed verification result hash is valid by using the platform public key 422-2. In addition, the platform private key 524 may be used to decrypt the encrypted device hash. The device 400 may encrypt the device hash by using the platform public key 422-2 and the platform 500 may decrypt the encrypted device hash by using the platform private key 524.

The device public key 525 may be used for the platform 500 to encrypt the verification result hash by the asymmetric cipher 523. As described with reference to FIGS. 9 and 14, the platform 500 may encrypt the verification result hash by using the device public key 525 and the device 400 may decrypt the encrypted verification result hash by using the device private key 422-3. In addition, the device public key 525 may be used to determine an electronic signature of the device hash.

The random number generator 530 may generate the nonce data required to verify integrity. In some embodiments, the random number generator 530 may generate the nonce data when it is required to measure the firmware hash and may transmit the nonce data to the PA RoT 520.

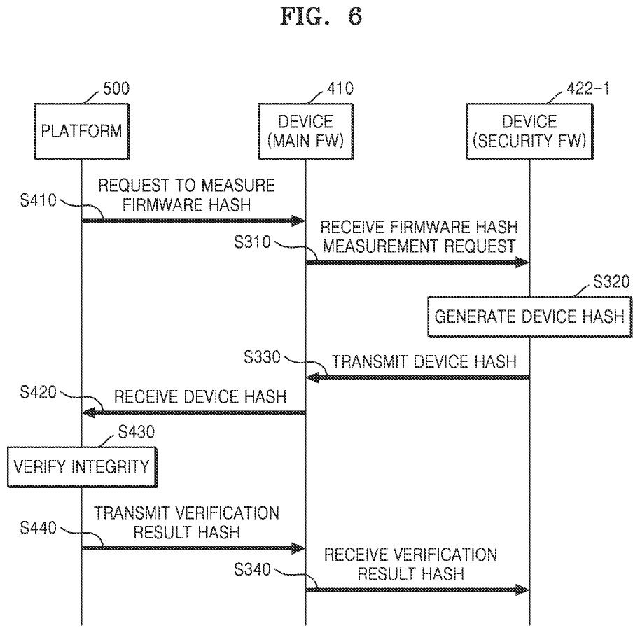

FIGS. 6 to 10 are flowcharts illustrating operations of the device 400 and the platform 500 for verifying integrity when the platform 500 requests integrity verification. FIGS. 6 to 10 may be described with reference to FIGS. 3 to 5 described above.

FIG. 6 is a flowchart illustrating an integrity verification method of FIGS. 7 and 10. Referring to FIG. 6, the integrity verification method of FIG. 6 may be described by operations of the platform 500 and the main firmware 410 and the security firmware 422-1 of the device 400. In FIG. 6, operations S310 to S340 of FIG. 7 and operations S410 to S440 of FIG. 9 are illustrated. The operation of the device 400 after operation S340 and the operation of the platform 500 after operation S440, which are not shown in FIG. 6, may be described with reference to FIGS. 7 and 9.

In operation S410, the platform 500 may generate the firmware hash measurement request including the nonce data and may transmit the generated firmware hash measurement request to the main firmware 410 of device 400.

In operation S310, the security firmware 422-1 of device 400 may receive the firmware hash measurement request including the nonce data from the platform 500 via the main firmware 410 of device 400.

In operation S320, the security firmware 422-1 of device 400 may generate the device hash with the hash generator 421-2. The hash generator 421-2 may generate the main firmware hash based on the address and size of the main firmware 410. Then, the hash generator 421-2 may generate the device hash by calculating the hash after serially concatenating the device RTC data 422-1A, the nonce data, and the main firmware hash. That is, the device hash may be expressed as HASH(DEVICE RTC DATAINONCEIHASH(MAIN FW)).

In operation S330, the security firmware 422-1 of device 400 may transmit the device hash generated in operation S320 through the main firmware 410.

In operation S420, the platform 500 may receive the device hash generated by the device 400 as a response to operation S410.

In operation S430, the platform 500 may generate the verification result hash by verifying the integrity of the device hash. As described with reference to FIG. 10, the integrity of the device hash may be verified by determining whether the reference hash is within an effective range of the device hash while the reference hash changes.

In operation S440, the platform 500 may transmit the verification result hash to the main firmware 410 of device 400.

In operation S340, the security firmware 422-1 of device 400 may receive the verification result hash from the platform 500 through the main firmware 410.

FIG. 7 is a flowchart illustrating operation S300 of the device 400 for verifying integrity when the platform 500 requests integrity verification according to an embodiment of the disclosure. The operation S300 of the device 400 may include a plurality of operations S310 to S371.

In operation S310, the device 400 may receive the firmware hash measurement request including the nonce data from the platform 500.

In operation S320, the device 400 may generate the device hash by the hash generator 421-2. The hash generator 421-2 may generate the main firmware hash by accessing memory in which the main firmware information is stored. Then, the hash generator 421-2 may generate the device hash by calculating the hash after serially concatenating the device RTC data 422-1A, the nonce data 422-1B, and the main firmware hash. That is, the device hash may be expressed as HASH(DEVICE RTC DATAINONCEIHASH(MAIN FW)). In an embodiment, the device 400 may generate an electronically signed device hash by encrypting the device hash by using the device private key 422-3. In another embodiment, the device 400 may generate the encrypted device hash by encrypting the device hash by using the platform public key 422-2. In addition, the device 400 may generate the electronically signed device hash by using the device private key 422-3 to encrypt the electronically signed device hash by using the platform public key 422-2.

In operation S330, the device 400 may transmit the device hash generated in operation S320 through the main firmware 410.

In operation S340, the device 400 may receive the verification result hash from the platform 500 through the main firmware 410.

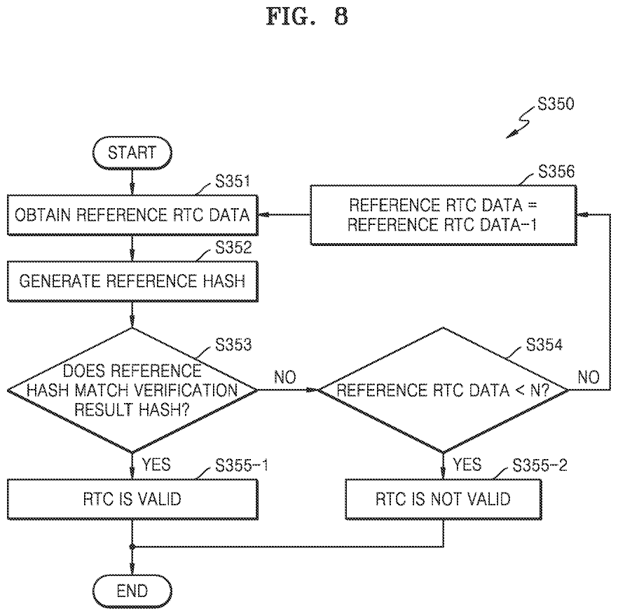

In operation S350, as described with reference to FIG. 8, the device 400 may determine whether the verification result hash is generated by the platform RTC data 521 within the effective range.

In operation S360, the device 400 may determine whether the verification result hash received from the platform 500 is PASS or FAIL. The device 400 may perform operation S370 when the verification result hash is PASS and may perform operation S371 when the verification result hash is FAIL. The device 400 may perform operation S371 when an RTC of the verification result hash is not valid or the device 400 does not receive the verification result hash although a certain amount of time has passed.

In operation S370, the device 400 may perform a normal sequence operation of transmitting and receiving a signal between the platform 500 and the device 400 to drive the device 400 under the premise that the device 400 has integrity.

In operation S371, the device 400 may perform an error sequence operation to respond to lack of integrity. The device 400 may zeroize SSPs so that the attacker may not use the SSPs, such as the device private key 422-3.

FIG. 8 is a flowchart illustrating operation S350 of determining the RTC of the verification result hash of FIG. 7. The operation S350 of determining the RTC of the verification result hash may be based on the fact that the RTC of the verification result hash is valid when there is a difference within the effective range between the platform RTC data, when the verification result hash is generated by the platform 500, and the device RTC data 422-1A when the device 400 receives the verification result hash. Because the device 400 may receive the verification result hash obtained by converting the platform RTC data 521 into a hash value together with the integrity verification result, it may be difficult to directly compare the verification result hash with the device RTC data 422-1A. Therefore, the device 400 may obtain a reference hash value while changing the device RTC data 422-1A within the effective range and may determine whether there is a value equal to the verification result hash. The operation S350 of determining the RTC of the verification result hash may include a plurality of operations S351 to S356, which will be described in detail as follows.

In operation S351, the device 400 may obtain reference RTC data for generating the reference hash of operation S352. The reference RTC data may be the device RTC data 422-1A when the verification result hash is received as an initial value in operation S340 of FIG. 7. For example, when the device 400 receives the verification result hash in operation S340 at 14:5:32, the reference RTC data may be 14:5:32.

In operation S352, the device 400 may generate the reference hash with the hash generator 421-2. The reference hash may be calculated after serially concatenating the reference RTC data and the integrity verification result. That is, the reference hash may be expressed as HASH(REF RTC DATAIRESULT). Here, the reference RTC data may be obtained in operation S351 and the integrity verification result may be read from the verification result hash.

In operation S353, the device 400 may determine whether the verification result hash matches the reference hash. When the verification result hash matches the reference hash, the process proceeds to operation S355-1 so that the device 400 may determine that the RTC of the verification result hash is valid. On the other hand, when the verification result hash does not match the reference hash, the process may proceed to operation S354.

In operation S354, it may be determined whether the RTC of the verification result hash will be continuously checked by comparing the reference RTC data with N. N may be data for determining whether the reference RTC data is within the effective range. N may be calculated by subtracting effective range from an initial reference RTC data. For example, when the effective range is 30 seconds and the reference RTC data initially obtained in operation S351 represents 14:5:32, N may be data representing 14:5:2 obtained by subtracting the effective range from the reference RTC data.

When the reference RTC data is greater than or equal to N, the reference RTC data may be reduced by one second in operation S356. If the reference RTC data is later than N, it may correspond to a greater value than N. After operation S356, operations S351 to S353 may be repeated. In other words, the device 400 may generate the reference hash while reducing the reference RTC data by one second within the effective range of 30 seconds from 14:5:32 when the test result hash is received and may determine whether the reference hash matches the verification result hash, through which it may be determined whether the verification result hash is generated based on the platform RTC data 521 within the effective range. When the reference RTC data is less than N, the process proceeds to operation S355-2 so that the device 400 may determine that the RTC of the verification result hash is not valid.

In the operation of determining the RTC data of the verification result hash as illustrated in FIG. 8, it may be determined whether the verification result hash transmitted by the platform 500 is valid by determining whether the platform RTC data that the attacker may access is within the effective range. When the attacker modulates the verification result hash, because it may be determined by the security system 420 of the device 400 that the verification result hash is modulated through the RTC data, it is possible to prevent conventional problems (for example, data items related to security of the device 400 supposed not to be deleted are deleted by the attacker) from occurring due to the modulation of the verification result hash.

FIG. 9 is a flowchart illustrating operation S400 of the platform 500 for verifying integrity when the platform 500 requests integrity verification according to an embodiment of the disclosure. The operation S400 of the platform 500 may include a plurality of operations S410 to S461.

In operation S410, the platform 500 may generate the firmware hash measurement request including the nonce data and may transmit the generated firmware hash measurement request to the device 400. The platform 500 may prevent the replay attack by verifying whether the hash transmitted by the device 400 in response to the firmware hash measurement request has information matching the nonce data transmitted by the platform 500. According to an embodiment, when the device RTC data 422-1A is initialized to the same value when the device 400 is booted, because the attacker may predict the device RTC data 422-1A, the nonce data may be used to prevent the replay attack together with the device RTC data 422-1A.

In operation S420, the platform 500 may receive the device hash generated by the device 400 as a response to operation S410.

In operation S430, the platform 500 may generate the integrity verification result by verifying the integrity of the device hash. As described with reference to FIG. 10, the integrity of the device hash may be verified by determining whether the reference hash is within an effective range of the device hash while the reference hash continuously changes. The platform 500 may generate the verification result hash by calculating the hash after serially concatenating the integrity verification result and the platform RTC data when the integrity verification result is generated. That is, the verification result hash may be expresses as HASH(PLATFORM RTC DATAIRESULT).

In an embodiment, the platform 500 may generate an electronically signed verification result hash by encrypting the verification result hash by using the platform private key 524. In another embodiment, the platform 500 may generate an encrypted verification result hash by encrypting the verification result hash by using the device public key 525. In addition, the platform 500 may encrypt the electronically signed verification result hash by using the device public key 525 after generating the electronically signed verification result hash by using the platform private key 524.

In operation S440, the platform 500 may transmit the verification result hash to the device 400.

In operation S450, the platform 500 may determine which operation is to be performed between the normal sequence operation and the error sequence operation in accordance with the integrity verification result. The platform 500 may perform the normal sequence operation in the next operation when the integrity verification result is PASS and may perform the error sequence operation in the next operation when the integrity verification result is FAIL.

In operation S460, the platform 500 may perform the normal sequence operation of transmitting and receiving the signal to and from the device 400 under the premise that the device 400 has integrity.

In operation S461, the platform 500 may perform the error sequence operation to respond to lack of integrity of the device 400. For example, the platform 500 may perform a firmware recovery operation of initializing the main firmware 410 of the device 400.

FIG. 10 is a flowchart illustrating integrity verification operation S430 of FIG. 9. The integrity verification operation may be based on the integrity verification result being a PASS when there is a difference within the effective range between the device RTC data 422-1A when the device hash is generated by the device 400 and the platform RTC data 521 when the device hash is received by the platform 500. Because the platform 500 may receive the device hash obtained by converting the device RTC data 422-1A into a hash value together with the nonce data and the main firmware hash, it may be difficult to directly compare the device hash with the device RTC data 422-1A, due to a lapse of time between the two events. Therefore, the platform 500 may obtain a reference hash value with the nonce data and the main firmware hash while changing the platform RTC data 521 within the effective range and may determine whether there is a value that is the same as the device hash. The integrity verification operation may include a plurality of operations S431 to S436, which will be described in detail as follows.

In operation S431, the platform 500 may obtain reference RTC data for generating the reference hash of operation S432. The reference RTC data may be the platform RTC data when the device hash is received as an initial value in operation S420 of FIG. 9. For example, when the platform 500 receives the device hash in operation S420 at 14:5:32, the reference RTC data may mean 14:5:32.

In operation S432, the platform 500 may generate the reference hash by the hash generator 522. The reference hash may be calculated after serially concatenating the reference RTC data, the nonce data, and the main firmware hash. That is, the reference hash may be expressed as HASH(REF RTC DATAINONCEIHASH(MAIN FW)). Here, the reference RTC data may be obtained in operation S431 and the nonce data may be included in the firmware hash measurement request in operation S410 of FIG. 9. The main firmware hash may be obtained from a hash table 510 of FIG. 5.

In operation S433, the platform 500 may determine whether the device hash matches the reference hash. When the device hash matches the reference hash, the process proceeds to operation S435-1 so that the platform 500 may generate a result that the device 400 passes the integrity verification. On the other hand, when the device hash does not match the reference hash, the process may proceed to operation S434.

In operation S434, it may be determined whether the integrity verification will be continuously performed by comparing the reference RTC data with N. N may be data for determining whether the reference RTC data is within the effective range. For example, when the effective range is 30 seconds and the reference RTC data initially obtained in operation S431 represents 14:5:32, N may be data representing 14:5:2 obtained by subtracting the effective range from the reference RTC data.

When the reference RTC data is greater than or equal to N, the reference RTC data may be reduced by one second in operation S436. After operation S436, operations S431 to S433 may be repeated. In other words, the platform 500 may generate the reference hash while reducing the reference RTC data by one second within the effective range of 30 seconds from 14:5:32 when the device hash is received and may determine whether the reference hash matches the device hash, through which it may be determined whether the device hash is generated based on the device RTC data 422-1A within the effective range. When the reference RTC data is less than N, the process proceeds to operation S435-2 so that the platform 500 may generate a result that the device 400 fails the integrity verification.

In the integrity verification operation illustrated in FIG. 10, the integrity of the device 400 may be verified by determining whether the device RTC data 422-1A that the main firmware 410 may not access is within the effective range. Therefore, when the attacker modulates the main firmware 410 of the device 400 to perform the replay attack, because it may be determined by the platform 500 that the main firmware 410 of the device 400 is modulated to perform the replay attack, the platform 500 may prevent the replay attack. In addition, it is possible to prevent the conventional problems (for example, the data items related to the security of the device 400 supposed not to be deleted are deleted by the attacker) from occurring due to the replay attack.

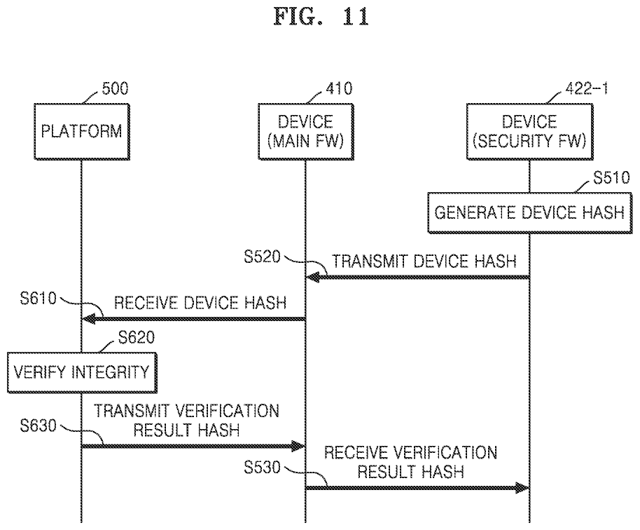

FIGS. 11 to 15 are flowcharts illustrating operations of the device 400 and the platform 500 for verifying integrity when the device 400 requests integrity verification. FIGS. 11 to 15 may be described with reference to FIGS. 3 to 5 described above.

Unlike FIGS. 6 to 10, FIGS. 11 to 15 illustrate that the device 400 requests integrity verification although the platform 500 does not request the integrity verification first when it is required for the device 400 to use a security function.

FIG. 11 is a flowchart illustrating an integrity verification method of FIGS. 12 and 14. Referring to FIG. 11, the integrity verification method S500 of FIG. 11 may be described by operations of the platform 500 and the main firmware 410 and the security firmware 422-1 of the device 400. In FIG. 11, operations S510 to S530 of FIG. 12 and operations S610 to S630 of FIG. 14 are illustrated. The operation of the device 400 after operation S530 and the operation of the platform 500 after operation S630, which are not shown in FIG. 11, may be described with reference to FIGS. 12 and 14.

In operation S510, the security firmware 422-1 of device 400 may generate the device hash using the hash generator 421-2 before using the security function. The hash generator 421-2 may generate the main firmware hash based on the address and size of the main firmware 410. Then, the hash generator 421-2 may generate the device hash by calculating the hash after serially concatenating the device RTC data 422-1A and the main firmware hash. That is, the device hash may be expressed as HASH(DEVICE RTC DATAIHASH(MAIN FW)).

In operation S520, the device 400 may transmit the device hash generated in operation S510 through the main firmware 410.

In operation S610, the platform 500 may receive the device hash generated by the device 400.

In operation S620, the platform 500 may generate the integrity verification result by verifying the integrity of the device hash. As described with reference to FIG. 15, the integrity of the device hash may be verified by determining whether the reference hash is within an effective range of the device hash, while the reference hash continuously changes (e.g., increases with time).

In operation S630, the platform 500 may transmit the verification result hash to the main firmware 410 of device 400.

In operation S530, the security firmware 422-1 of device 400 may receive the verification result hash from the platform 500 through the main firmware 410.

FIG. 12 is a flowchart illustrating an operation of the device 400 for verifying integrity when the device 400 requests integrity verification according to an embodiment of the disclosure. The operation of the device 400 may include a plurality of operations S510 to S561.

In operation S510, the device 400 may generate the device hash with the hash generator 421-2 before using the security function. The hash generator 421-2 may generate the main firmware hash based on the address and size of the main firmware 410. Then, the hash generator may generate the device hash by calculating the hash after serially concatenating the device RTC data 422-1A and the main firmware hash. That is, the device hash may be expressed as HASH(DEVICE RTC DATAIHASH(MAIN FW)). In an embodiment, the device 400 may generate an electronically signed device hash by encrypting the device hash by using the device private key 422-3. In another embodiment, the device 400 may generate the encrypted device hash by encrypting the device hash by using the platform public key 422-2. In addition, the device 400 may generate the electronically signed device hash by using the device private key 422-3 to encrypt the electronically signed device hash by using the platform public key 422-2.

In operation S520, the device 400 may transmit the device hash generated in operation S510 through the main firmware 410.

In operation S530, the security firmware 422-1 of device 400 may receive the verification result hash from the platform 500 through the main firmware 410.

In operation S540, the device 400 may determine whether the verification result hash is generated by the platform RTC data 521 in the effective range.

In operation S550, the device 400 may determine whether the verification result hash received from the platform 500 is PASS or FAIL. The device 400 may perform operation S560 when the verification result hash is PASS and may perform operation S561 when the verification result hash is FAIL. The device 400 may perform operation S561 when an RTC of the verification result hash is not valid or the device 400 does not receive the verification result hash although a certain amount of time has passed.

In operation S560, the device 400 may perform a normal sequence operation of transmitting and receiving a signal between the platform 500 and the device 400 to drive the device 400 under the premise that the device 400 has integrity.

In operation S561, the device 400 may perform an error sequence operation to respond to a lack of integrity. The device 400 may zeroize SSPs so that the attacker may not use the SSPs, such as the device private key 422-3.

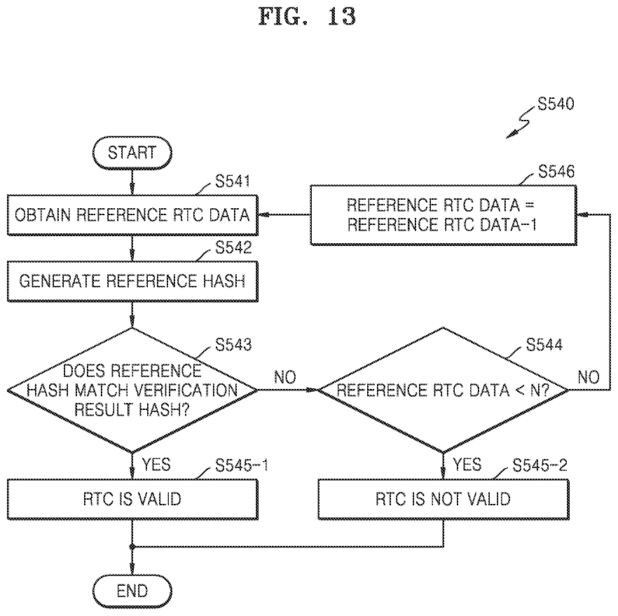

FIG. 13 is a flowchart illustrating operation S540 of determining the RTC of the verification result hash of FIG. 12. Because the: (1) only difference between FIG. 8 and FIG. 13 is that the platform 500 generates the verification result hash in response to the integrity verification request of the device 400 and (2) operations of FIG. 13 may be described with reference to FIG. 8, a description previously given with reference to FIG. 8 will not be given with respect to FIG. 13.

The operation S540 of determining the RTC of the verification result hash may include a plurality of operations S541 to S546, which will be described in detail as follows.

In operation S541, the device 400 may obtain reference RTC data for generating the reference hash of operation S542. The reference RTC data may be the device RTC data 422-1A when the verification result hash is received as an initial value in operation S530 of FIG. 12. For example, when the device 400 receives the verification result hash in operation S530 at 14:5:32, the reference RTC data may mean 14:5:32.

In operation S542, the device 400 may generate the reference hash with the hash generator 421-2. The reference hash may be calculated after serially concatenating the reference RTC data and the integrity verification result. That is, the reference hash may be expressed as HASH(REF RTC DATAIRESULT). Here, the reference RTC data may be obtained in operation S541 and the integrity verification result may be read from the verification result hash.

In operation S543, the device 400 may determine whether the verification result hash matches the reference hash. When the verification result hash matches the reference hash, the process proceeds to operation S545-1 so that the device 400 may determine that the RTC of the verification result hash is valid. On the other hand, when the verification result hash does not match the reference hash, the process may proceed to operation S544.

In operation S544, it may be determined whether the RTC of the verification result hash will be continuously checked by comparing the reference RTC data with N. N may be data for determining whether the reference RTC data is within the effective range. For example, when the effective range is 30 seconds and the reference RTC data initially obtained in operation S541 represents 14:5:32, N may be data representing 14:5:2 obtained by subtracting the effective range from the reference RTC data.

When the reference RTC data is greater than or equal to N, the reference RTC data may be reduced by one second in operation S546. After operation S546, operations S541 to S543 may be repeated. In other words, the device 400 may generate the reference hash while reducing the reference RTC data by one second within the effective range of 30 seconds from 14:5:32 when the test result hash is received and may determine whether the reference hash matches the verification result hash, through which it may be determined whether the verification result hash is generated based on the platform RTC data 521 within the effective range. When the reference RTC data is less than N, the process proceeds to operation S545-2 so that the device 400 may determine that the RTC of the verification result hash is not valid.

FIG. 14 is a flowchart illustrating an operation of the platform 500 for verifying integrity when the device 400 requests integrity verification according to an embodiment of the disclosure. The operation S600 of the platform 500 may include a plurality of operations S610 to S651.

In operation S610, the platform 500 may receive the device hash generated by the device 400.

In operation S620, the platform 500 may generate the integrity verification result by verifying the integrity of the device hash. As described with reference to FIG. 15, the integrity of the device hash may be verified by determining whether the reference hash is within an effective range of the device hash, while the reference hash changes. In an embodiment, the platform 500 may generate an electronically signed verification result hash by encrypting the verification result hash by using the platform private key 524. In another embodiment, the platform 500 may generate an encrypted verification result hash by encrypting the verification result hash by using the device public key 525. In addition, the platform 500 may encrypt the electronically signed verification result hash by using the device public key 525 after generating the electronically signed verification result hash by using the platform private key 524.

In operation S630, the platform 500 may transmit the verification result hash to the device 400.

In operation S640, the platform 500 may determine which operation is to be performed between the normal sequence operation and the error sequence operation in accordance with the integrity verification result. The platform 500 may perform the normal sequence operation in the next operation when the integrity verification result is PASS and may perform the error sequence operation in the next operation when the integrity verification result is FAIL.

In operation S650, the platform 500 may perform the normal sequence operation of transmitting and receiving the signal to and from the device 400 under the premise that the device 400 has integrity.

In operation S651, the platform 500 may perform the error sequence operation to respond to a lack of integrity of the device 400. For example, the platform 500 may perform a firmware recovery operation of initializing the main firmware 410 of the device 400.

FIG. 15 is a flowchart illustrating integrity verification operation S620 of FIG. 14. Because the only difference between FIG. 10 and FIG. 15 lies in the generated reference hash, the description previously given with reference to FIG. 10 will not be given with respect to FIG. 15.

The integrity verification operation S620 may include a plurality of operations S621 to S626, which will be described in detail as follows.

In operation S621, the platform 500 may obtain reference RTC data for generating the reference hash of operation S622. The reference RTC data may be the platform RTC data when the device hash is received as an initial value in operation S610 of FIG. 14. For example, when the platform 500 receives the device hash in operation S610 at 14:5:32, the reference RTC data may mean 14:5:32.

In operation S622, the platform 500 may generate the reference hash with the hash generator 522. The reference hash may be calculated after serially concatenating the reference RTC data and the main firmware hash. That is, the reference hash may be expressed as HASH(REF RTC DATAIHASH(MAIN FW)). Here, the reference RTC data may be obtained in operation S621. The main firmware hash may be obtained from the hash table 510 of FIG. 5.

In operation S623, the platform 500 may determine whether the device hash matches the reference hash. When the device hash matches the reference hash, the process proceeds to operation S625-1 so that the platform 500 may generate a result that the device 400 passes the integrity verification. On the other hand, when the device hash does not match the reference hash, the process may proceed to operation S624.

In operation S624, it may be determined whether the integrity verification will be continuously performed by comparing the reference RTC data with N. N may be data for determining whether the reference RTC data is within the effective range. For example, when the effective range is 30 seconds and the reference RTC data initially obtained in operation S621 represents 14:5:32, N may be data representing 14:5:2 obtained by subtracting the effective range from the reference RTC data.

When the reference RTC data is greater than or equal to N, the reference RTC data may be reduced by one second in operation S626. After operation S626, operations S621 to S623 may be repeated. In other words, the platform 500 may generate the reference hash while reducing the reference RTC data by one second within the effective range of 30 seconds from 14:5:32 when the device hash is received and may determine whether the reference hash matches the device hash, through which it may be determined whether the device hash is generated based on the device RTC data 422-1A within the effective range. When the reference RTC data is less than N, the process proceeds to operation S625-2 so that the platform 500 may generate a result that the device 400 fails the integrity verification.

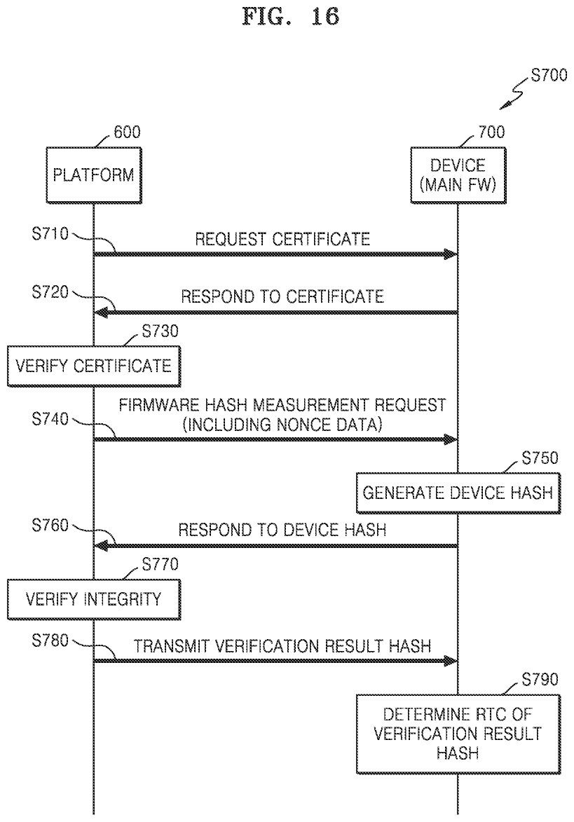

FIG. 16 is a flowchart illustrating an integrity verification method to which an open compute project (OCP) standard is applied according to an embodiment of the disclosure. The OCP is a group starting around Facebook in 2011 to share technologies related to a data center, a server, and a cloud. OCP standards are determined to share technology such as the data center in the OCP. OCP members share technologies such as a data center design and a server system by applying the OCP standards to the data center. One of the OCP standards is to verify integrity of a device in a platform such as data center or the server. The OCP standard may be applied to the integrity verification method according to the disclosure.

FIG. 16 may be described with reference to FIGS. 3 to 10 described above. Referring to FIG. 16, the integrity verification method of FIG. 16 may be described through operations of a platform 600 and a device 700. As described with reference to FIG. 3, the device 700 of FIG. 16 may include the main firmware 410 and the security system 420. As described with reference to FIG. 4, the security system 420 of the device 700 of FIG. 16 may include the security memory 422 and the encryption module 421.

The integrity verification method S700 of FIG. 16 may include operations S710 to S790. After operation S790, the operations of the device 700 and the platform 600 may be described with reference to FIGS. 7 and 9. FIG. 16 illustrates the integrity verification method when the platform 600 does not store a certificate chain. When the platform 600 stores the certificate chain, operations S710 to S720 may be omitted.

In operation S710, the platform 600 may request a certificate from the device 700. The certificate may belong to the Alias certificate chain in accordance with the OCP standard. The Alias key may be used for the Alias certificate chain. Although the Alias key is exposed to the outside, it is safer than when the Device ID key is exposed.

In operation S720, the device 700 may respond by communicating the certificate to the platform 600 as a response to operation S710. The device 700 may communicate the certificate belonging to the Alias certificate chain to the platform 600.

In operation S730, the platform 600 may verify the certificate that the device 700 sends. When the certificate that the device 700 sends is verified to be valid in accordance with the Alias certificate chain, operations S740 to S790 may be performed. However, when the certificate that the device 700 sends is not valid, the device 700 may fail to authenticate and operations S740 to S790 may not be performed.

In operation S740, the platform 600 may generate the firmware hash measurement request including the nonce data and may transmit the generated firmware hash measurement request to the device 700. As described with reference to FIG. 5, the nonce data may be generated by the random number generator 530.

In operation S750, the device 700 may generate the device hash with the hash generator 421-2 as illustrated in FIG. 16. The hash generator 421-2 may generate the main firmware hash based on the main firmware information 422-1C. Then, the hash generator 522 may generate the device hash by calculating the hash after serially concatenating the device RTC data 422-1A, the nonce data 422-1B, and the main firmware hash. That is, the device hash may be expressed as HASH(DEVICE RTC DATAINONCEIHASH(MAIN FW)).

In operation S760, the device 700 may communicate the device hash generated in operation S750 to the platform 600 through the main firmware 410.

In operation S770, the platform 600 may generate the verification result hash by verifying the integrity of the device hash. As described with reference to FIG. 10, the integrity of the device hash may be verified by determining whether the reference hash is within an effective range of the device hash, while changing the reference hash.

In operation S780, the platform 600 may transmit the verification result hash to the device 700.

In operation S790, the device 700 may check the RTC of the verification result hash received from the platform 600. As described with reference to FIG. 8, the RTC of the verification result hash may be checked by determining whether the reference hash is within an effective range of the verification result hash, while changing the reference hash.

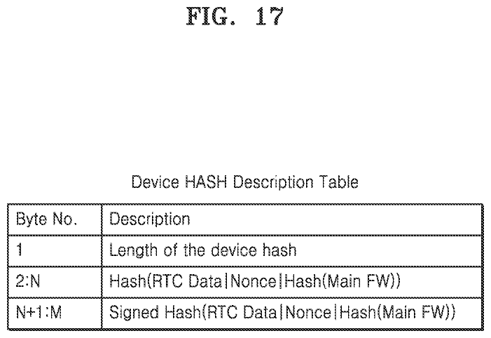

FIG. 17 is a table illustrating a device hash to which the OCP standard is applied according to an embodiment of the disclosure. In some embodiments, the device hash of FIG. 17 may be generated in operation S750 of FIG. 16.

The device hash may include first to Mth bytes 1 to M.

The first byte of the device hash may have information on a length of the device hash.

As described with reference to FIG. 4, second to Nth bytes of the device hash may have information obtained by calculating the hash after serially concatenating the device RTC data 422-1A, the nonce data 422-1B, and the main firmware hash.

(N+1)th to Mth bytes of the device hash may have information obtained by electronically signing the second to Nth bytes of the device hash. In some embodiments, the electronic signature may be performed by using the device private key 422-3 as described with reference to FIG. 4.

As is traditional in the field, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure. An aspect of an embodiment may be achieved through instructions stored within a non-transitory storage medium and executed by a processor.

While the disclosure has been particularly shown and described with reference to embodiments thereof, it will be understood that various changes in form and details may be made therein without departing from the spirit and scope of the following claims.

1. A device connected to a platform, the device comprising:
a security system including device real time clock (RTC) data; and
main firmware communicating with the platform, wherein:
the security system generates a device hash from the device RTC data and a main firmware hash, and
the main firmware provides a response including the device hash to the platform.

2. The device of claim 1, wherein:
the main firmware receives a firmware hash measurement request signal including nonce data from the platform, and
the security system generates a device hash from the device RTC data, the main firmware hash, and the nonce data based on the firmware hash measurement request signal.

3. The device of claim 1, wherein the device RTC data is synchronized with platform RTC data of the platform when the device is booted.

4. The device of claim 1, wherein the security system generates a device hash electronically signed based on a device private key.

5. The device of claim 1, wherein the security system encrypts the device hash based on a platform public key.

6. The device of claim 1, wherein the security system generates the device hash when a security function is used.

7. The device of claim 1, wherein:
the main firmware receives a verification result hash including platform RTC data from the platform, and
the security system determines whether the platform RTC data is within an effective range.

8. The device of claim 7, wherein the security system verifies an electronic signature of the verification result hash based on a platform public key.

9. The device of claim 7, wherein the security system performs a normal sequence operation when the platform RTC data is within the effective range.

10. The device of claim 7, wherein the security system performs an error sequence operation when the platform RTC data deviates from the effective range.

11. A platform connected to a device, the platform comprising:
a platform root of trust (RoT) verifying integrity of a device hash; and
a hash table storing a main firmware hash of the device, wherein
the platform RoT verifies the integrity of the device hash based on platform real time clock (RTC) data and the main firmware hash.

12. The platform of claim 11, wherein the platform RoT generates a firmware hash measurement request signal including nonce data and verifies the integrity of the device hash based on the nonce data.

13. The platform of claim 11, wherein the platform RoT determines whether device RTC data of the device hash is within an effective range.

14. The platform of claim 13, wherein the platform RoT performs a normal sequence operation when the device RTC data is within the effective range.

15. The platform of claim 13, wherein the platform RoT performs an error sequence operation when the device RTC data deviates from the effective range.

16. The platform of claim 11, wherein the platform RoT verifies an electronic signature of the device hash based on a device public key.

17. The platform of claim 11, wherein the platform RoT generates a verification result hash electronically signed based on a platform private key and provides the electronically signed verification result hash to the device.

18. A method of verifying integrity of a device connected to a platform, the method comprising:
synchronizing platform real time clock (RTC) data with device RTC data, the device generating a device hash from the device RTC data and a main firmware hash of the device; and
verifying, by the platform, integrity of the device hash based on the platform RTC data and a firmware hash stored in the platform.

19. The method of claim 18, wherein the generating of the device hash is performed in response to a firmware hash measurement request signal generated by the platform.

20. The method of claim 19, wherein:
the firmware hash measurement request signal comprises nonce data, and
integrity of the device hash is verified by the platform based on the nonce data.

21-26. (canceled)
